(19) United States
(12) Patent Application Publication
(10) Pub. No.: US 2008/0034761 A1
(43) Pub. Date: Feb. 14, 2008

(54) Method, Apparatus And Composition For Making Ice

(75) Inventor: Jason Hartley, Vancouver (CA)

Correspondence Address: PERKINS COIE LLP;PATENT-SEA, P.O. BOX 1247, SEATTLE, WA, 98111-1247, US

(73) Assignee: Orca Bay Arena Limited Partnership, Vancouver (CA)

(21) Appl. No.: 10/589,165

(22) PCT Filed: Feb. 13, 2004
(86) PCT No.: PCT/CA04/00204

§ 371 Date: Jul. 10, 2007

(51) Int. Cl. C02F 1/68; F25C 3/02

(52) U.S. Cl. 62/67; 62/124

(57) ABSTRACT

the present invention relates to a method, apparatus and composition for making ice. Water is first filtered to a commercially pratical level of purity and then an additive is mixed with the water until a desired degree of total alkalinity, hardness, and/or turbidity is achieved. Water so processed has been found to produce, upon freezing, ice having a fast, hard, uniform surface that consistently resists rutting, chipping, cutting, sinking and sintering during use over an extended period of time.

### BACKGROUND OF THE INVENTION

1. Field of the Invention

The present invention relates to a method, apparatus and composition for making ice. More particularly, the invention relates to processing the floodwater that is frozen into ice, such that it forms a suitable surface for playing fast-paced sports, for example hockey.

2. Description of Related Art

Some sports, for example hockey, are best played on an ice slab that has a fast, hard, uniform surface that consistently resists rutting, chipping, cutting, sinking and sintering during use over an extended period of time. Making such a slab of ice demands much care and attention.

The best such slabs of ice are commonly frozen as laminations of ice sheets, typically including sheets less than one millimetre thick. The first sheet is created by freezing floodwater over a refrigerated floor, and thereafter each successive sheet is frozen over the previous one.

There are so many factors to monitor and control when making and maintaining a good quality ice slab that the process has developed a reputation as a bit of a black art. Quality may be affected by the number and thickness of the laminations and the time intervals between freezing the laminations. The ice slab is affected by the temperature and the humidity of the surrounding environment; if an arena is brightly lit and full of hot-blooded spectators, then the arena's refrigeration and dehumidification systems have to compensate.

The nature of the floodwater that is frozen into ice sheets is also an important factor. Conventional wisdom has maintained that the purest water freezes into the best ice. To this end, elite rinks, such as those that host the National Hockey League, employ sophisticated filtration systems to process the available municipal water into purer floodwater. These filtration systems often include a mechanical filter, a deionization filter, and even a reverse osmosis filter.

Nevertheless, despite years of experience and access to sophisticated filtration technology, many rinks—even elite rinks—, continue to have difficulty making and maintaining good quality ice. Accordingly, what is needed is a better way to make an ice slab that has a fast, hard, uniform surface that consistently resists rutting, chipping, cutting, sinking and sintering during use over an extended period of time.

### SUMMARY OF THE INVENTION

The present invention is directed to this need.

According to one aspect of the invention, there is provided a method of processing water to create floodwater for ice-making. An additive is mixed into the water to produce floodwater having at least one of the following properties: 180 mg/L≦total alkalinity (CaCO₃)≦200 mg/L, 9 mg/L≦hardness (CaCO₃)≦12 mg/L, and 0 Nephelometric Turbidity Units≦turbidity≦1 Nephelometric Turbidity Units.

The method might also include filtering the water to a commercially practical degree of purity before mixing the additive into the water, including mechanically filtering the water, deionizing the water, or reverse-osmotically filtering the water. The method might also include heating the filtered water before mixing the additive into the water.

By way of example, water filtered to a commercially practical degree of purity might be characterized by having: less than one part per million of each of aluminum, antimony, arsenic, barium, beryllium, bismuth, boron, cadmium, chromium, cobalt, copper, lead, lithium, molybdenum, nickel, phosphorus, selenium, silicon, silver, strontium, sulphur, thalium, vanadium, calcium, magnesium, manganese, sodium, potassium, chloride (Cl), sulphate (SO₄), hardness (CaCO₃), bicarbonate alkalinity (HCO₃), hydroxide alkalinity (CO₃), carbonate alkalinity (OH); less than five parts per million of total alkalinity (CaCO3); a turbidity between 0-1 Nephelometric Turbidity Units; and a pH between 6.5 and 7.5.

Furthermore, an additive might be mixed into the water until the floodwater has at least one of the following properties: 7.5≦pH≦8.5, 190 mg/L≦bicarbonate alkalinity (HCO₃)≦210 mg/L, 8 mg/L≦sulphate concentration (SO₄)≦10 mg/L, 100 mg/L≦sodium concentration (Na)≦130 mg/L, 3 mg/L≦calcium concentration (Ca)≦6 mg/L, 55 mg/L≦chloride concentration (Cl)≦70 mg/L, and 3 mg/L≦silicon concentration (SiO₂) between≦7 mg/L.

As for the mixing additive, the additive might be a buffering salt or might more specifically be a composition comprising: 74% by mass sodium bicarbonate (NaHCO₃), 24% by mass sodium chloride (NaCl) and 2% by mass gypsum (CaSO₄.2H2O), mixed into the water until 36×10⁻² grams of the additive are present in each litre of water.

In one arrangement, the additive might be mixed into a first amount of water to create a mixture and then that mixture blended into a second amount of water.

According to another aspect of the invention, there is provided a composition of matter for mixing with water to create floodwater for making ice. The composition is such that when mixed with water it creates floodwater that has at least one of the following properties: 180 mg/L≦total alkalinity (CaCO₃)≦200 mg/L, 9 mg/L≦hardness (CaCO₃)≦12 mg/L, and 0 Nephelometric Turbidity Units≦turbidity≦1 Nephelometric Turbidity Units.

The composition might be formulated to mix with water that has been filtered to a commercially practical degree of purity, and to create floodwater that has at least one of the following properties: 7.5≦pH≦8.5, 190 mg/L≦bicarbonate alkalinity (HCO₃)≦210 mg/L, 8 mg/L≦sulphate concentration (SO₄)≦10 mg/L, 100 mg/L≦sodium concentration (Na)≦130 mg/L, 3 mg/L≦calcium concentration (Ca)≦6 mg/L, 55 mg/L≦chloride concentration (Cl)≦70 mg/L, and 3 mg/L≦silicon concentration (SiO₂) between ≦7 mg/L.

The composition might include a buffering salt, or more specifically might include 74% by mass sodium bicarbonate (NaHCO₃), 24% by mass sodium chloride (NaCl), and 2% by mass gypsum (CaSO₄.2H2O).

According to another aspect of the invention, there is provided a composition of matter for making ice. This composition includes a mixture of water having a commercially practical degree of purity and 36×10⁻² grams of an additive for each litre of water. More specifically, the additive might include might comprise 74% by mass sodium bicarbonate (NaHCO₃), 24% by mass sodium chloride (NaCl), and 2% by mass gypsum (CaSO₄.2H2O).

According to still another aspect of the invention, there is provided another composition of matter for making ice. This composition includes water that has at least one of the following properties: 180 mg/L <total alkalinity (CaCO₃)≦200 mg/L, 9 mg/L≦hardness (CaCO₃)≦12 mg/L, and 0 Nephelometric Turbidity Units≦turbidity ≦1 Nephelometric Turbidity Units.

This composition might further have one of the following properties: 7.5≦pH ≦8.5, 190 mg/L≦bicarbonate alkalinity (HCO₃)≦210 mg/L, 8 mg/L≦sulphate concentration (SO₄)≦10 mg/L, 100 mg/L≦sodium concentration (Na)≦130 mg/L, 3 mg/L≦calcium concentration (Ca)≦6 mg/L, 55 mg/L≦chloride concentration (Cl)≦70 mg/L, and 3 mg/L≦silicon concentration (SiO₂) between ≦7 mg/L.

This composition might further include a buffering salt and more specifically might include: 26×10⁻² grams of sodium bicarbonate (NaHCO₃) for each litre of water, 84×10⁻³ grams of sodium chloride (NaCl) for each litre of water, and 96×10⁻⁴ grams of gypsum (CaSO₄.2H2O) for each litre of water.

According to yet another aspect of the invention, there is provided an apparatus for processing water into floodwater for making ice. The apparatus includes a mixer connected to receive water having a commercially practical degree of purity and to receive an additive. The mixer is configured to mix the water and the additive to create a floodwater mixture.

The apparatus might further include a filtration stage for filtering water, connected to supply the filtered water to the mixer. This filtration stage might variously include a mechanical filter, a deionization filter, or a reverse-osmosis filter.

The apparatus might also include a heater for heating water, connected to supply the heated water to the mixer.

The apparatus might include a dispensing valve for controlling the amount of additive dispensed into the mixer for mixing with the water. A mix-tester could test a property of the mixture within the mixer, for example the mixture's: total alkalinity (CaCO₃), hardness (CaCO₃), turbidity, pH, bicarbonate alkalinity (HCO₃), sulphate concentration, sodium concentration (Na), calcium concentration (Ca), chloride concentration (Cl), or silicon concentration (SiO₂). In this arrangement, the setting of the dispensing valve could be responsive to the mix-tester.

The apparatus might also include a shunt valve for controlling the amount of water supplied to the mixer for mixing with the additive, and the setting of the shunt valve could also be responsive to the mix-tester.

The apparatus might also include a blender connected to receive water having a commercially practical degree of purity and mixture from the mixer for blending the water and the mixture to create a floodwater blend. Similar to the mixer, the blender could be connected to a mix valve for controlling the amount of mixture received by the blender for blending with the water and a main valve for controlling the amount of water received by the blender for blending with the mixture.

Furthermore, the apparatus might include a blend-tester for testing a property of the blend within the blender, for example the blend's: the mixture's: total alkalinity (CaCO₃), hardness (CaCO₃), turbidity, pH, bicarbonate alkalinity (HCO₃), sulphate concentration, sodium concentration (Na), calcium concentration (Ca), chloride concentration (Cl), or silicon concentration (SiO₂). In this arrangement, the setting of the mix valve or the main valve could be responsive to the blend-tester.

The apparatus might also include a mix flowmeter for measuring the flow of mixture into the blender or a main flowmeter for measuring the flow of filtered water into the blender. In this arrangement, the setting of the mix valve could be responsive to the mix flowmeter and the setting of the main valve could be responsive to the main flowmeter.

The apparatus might further include a control module responsive to at least one of: the mix-tester, the blend-tester, the mix flowmeter, and the main flowmeter. Furthermore, at least one of the dispensing valve, the shunt valve, the mix valve, and the main valve might be responsive to the control module. In this arrangement, the control module could control at least one of the dispensing valve, the shunt valve, the mix valve, and the main valve such that the blend has at least one of the following properties: 180 mg/L≦total alkalinity (CaCO₃)≦200 mg/L, 9 mg/L≦hardness (CaCO₃)≦12 mg/L, 0 Nephelometric Turbidity Units≦turbidity≦1 Nephelometric Turbidity Units, 7.5≦pH≦8.5, 190 mg/L≦bicarbonate alkalinity (HCO₃)≦210 mg/L, 8 mg/L≦sulphate concentration (SO₄)≦10 mg/L, 100 mg/L≦sodium concentration (Na)≦130 mg/L, 3 mg/L≦calcium concentration (Ca)≦6 mg/L, 55 mg/L≦chloride concentration (Cl)≦70 mg/L, and 3 mg/L≦silicon concentration (SiO₂) between ≦7 mg/L.

Further aspects and advantages of the present invention will become apparent upon considering the following drawings, description, and claims.

### DESCRIPTION OF THE INVENTION

The invention will be more fully illustrated by the following detailed description of specific embodiments in conjunction with the accompanying drawing figures, in which like reference numerals designate like parts throughout the various figures.

### BRIEF DESCRIPTION OF THE DRAWINGS

FIG. 1 is a schematic view of an apparatus according to one aspect of the present invention.

FIG. 2 is a schematic view of the apparatus of FIG. 1, detailing the connection of a control module.

### DETAILED DESCRIPTION OF SPECIFIC EMBODIMENTS

(a) Structure

The structure of the invention will now be illustrated by way of specific exemplary embodiments shown in the drawing figures and described in greater detail herein.

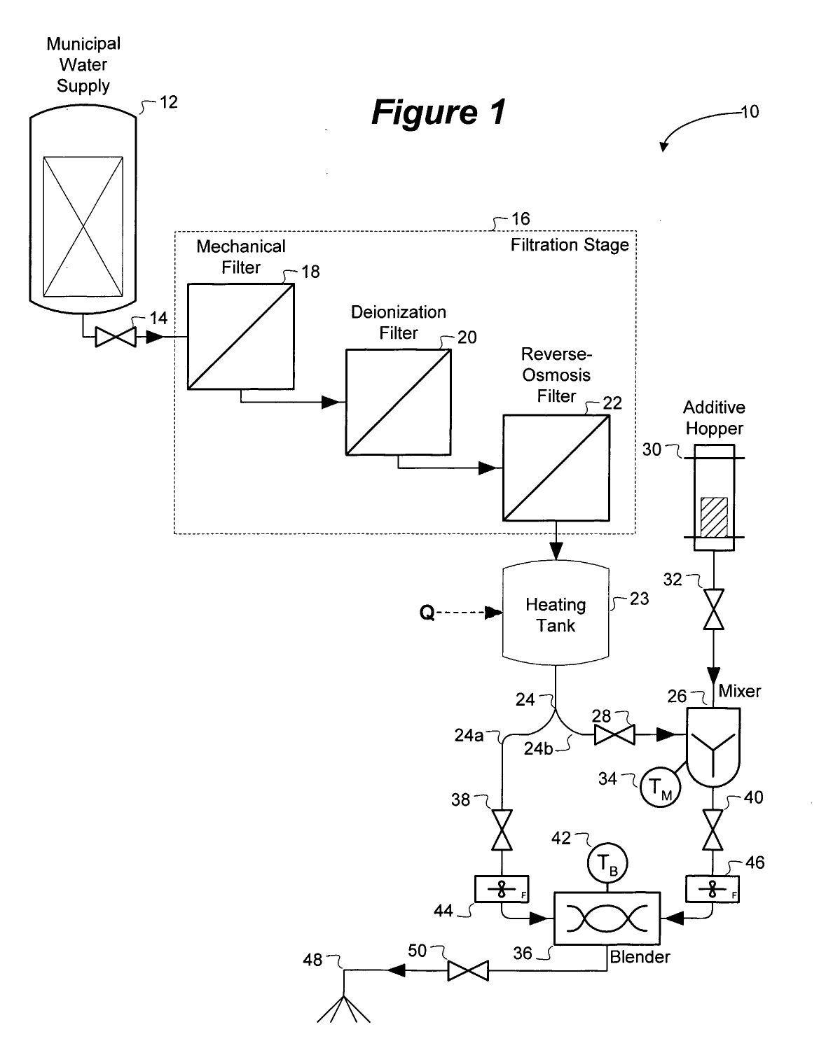

FIG. 1 shows a water treatment system according to one embodiment of the present invention, generally illustrated at 10. The water treatment system 10 is connected through a shut-off valve 14 to receive a supply of water from a source 12 that is not necessarily a part of the invention, for example a municipal water utility.

The shut-off valve 14 is connected to supply a filtration stage 16, which in this embodiment includes a mechanical filter 18, a deionization filter 20, and a reverse-osmosis filter 22 connected together in series. While for completeness of illustration both the deionization filter 20 and the reverse-osmosis filter 22 have been included, in commercial embodiments generally one or the other is considered sufficient.

The filtration stage 16 is connected to supply a heating tank 23. The heating tank 23 is connected to a source of energy Q and has a temperature set point, which in this embodiment is set to 74 degrees Celsius. Although illustrated as a tank in this embodiment, the heating tank 23 may be any sort of heating vessel, for example a continuous in-line heater. The heating tank 23 has a bifurcated output port 24, having both a main pipe 24a and a shunt 24b.

The shunt 24b is connected to supply a mixer 26 through a shunt valve 28. A hopper 30, which is adapted to store and dispense an additive, is connected to also dispense the additive into the mixer 26 through a dispensing valve 32. A mix-tester 34 is operable to test specific properties of the mixture within the mixer 26, as will be described in greater detail below. In this regard, the mix-tester 34 may be any well-known sensor or sensor system for testing one or more specific properties of the mixture. It should be understood that the mixture may be a mechanical mixture, a solution, or a suspension.

The water treatment system 10 further includes a blender 36, which is connected to receive flows from both the main pipe 24a and the mixer 26. In this embodiment, the main pipe 24a connects to the blender 36 through a main valve 38 and the mixer 26 connects to the blender 36 through a mix valve 40. Additionally, the water treatment system 10 may also include a main flowmeter 44 connected inline between the main pipe 24a and the blender 36 and a mix flowmeter 46 connected inline between the mixer 26 and the blender 36. A blend-tester 42 is operable to test specific properties of the blend within the blender 36, as will be described in greater detail below. In this regard, the blend-tester 42 may be any well-known sensor or sensor system for testing one or more specific properties of the blend.

The blender 36 is connected to supply the blend to a discharge line 48, in this embodiment conveniently through a discharge valve 50, the discharge line 48 being operable to discharge the blend onto a surface as floodwater for freezing into ice.

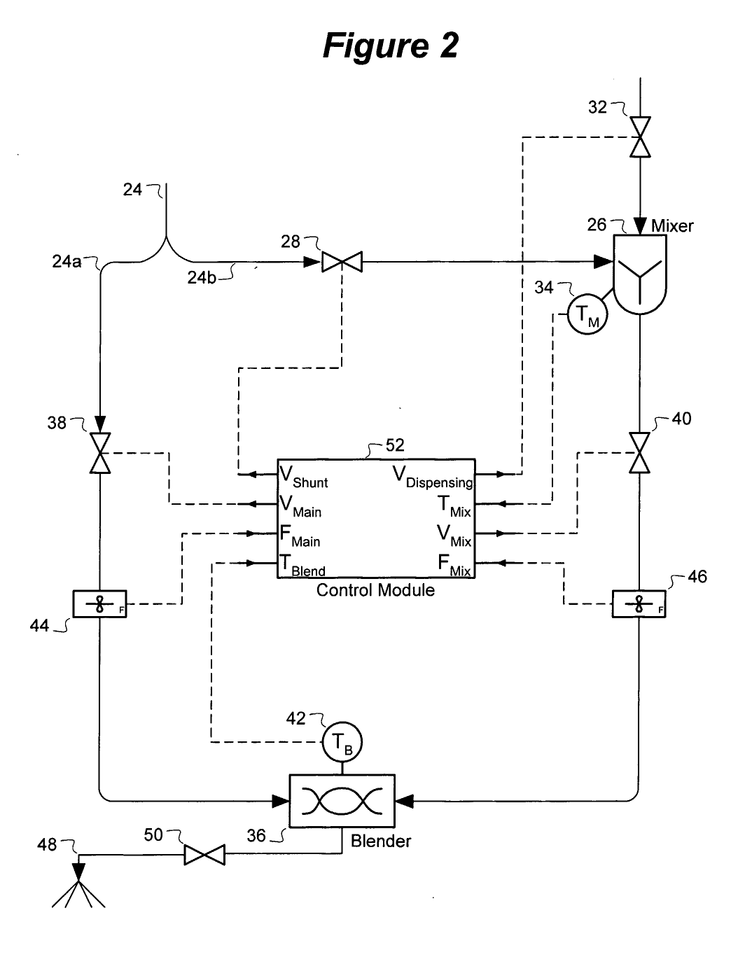

FIG. 2 shows that portion of the water treatment system 10 that follows the filtration stage 16, and in particular details a way to control the water treatment system 10, in this embodiment through a control module 52, be it electric, electronic, fluidic, hydraulic, hybrid, or otherwise. The control module 52 is connected to receive data signals encoding measurement data from the mix-tester 34, the blend-tester 42, the main flowmeter 44, and the mix flowmeter 46 and to issue in response command signals to the shunt valve 28, the dispensing valve 32, the main valve 38 and the mix valve 40, so as to urge the mixture in the mixer 26 and the blend in the blender 36 toward specifically desired properties as described below in greater detail.

(b) Operation

With reference to the both FIGS. 1 and 2, the operation of these specific embodiments of the invention will now be described.

Water from an external source 12 is received into the water treatment system 10 through the shut-off valve 14. The water is passed through the filtration stage 16 such it achieves a commercially practical degree of purity. By way of example only, for this purpose it has been found that water is sufficiently pure if it:

has less than one part per million of each of:
aluminum,
antimony,
arsenic,
barium,
beryllium,
bismuth,
boron,
cadmium,
chromium,
cobalt,
copper,
lead,
lithium,
molybdenum,
nickel,
phosphorus,
selenium,
silicon,
silver,
strontium,
sulphur,
thalium,
vanadium,
calcium,
magnesium,
manganese,
sodium,
potassium,
chloride (Cl),
sulphate (SO₄),
hardness (CaCO₃),
bicarbonate alkalinity (HCO₃),
hydroxide alkalinity (CO₃),
carbonate alkalinity (OH);

has less than five parts per million of total alkalinity (CaCO₃);

has a turbidity between 0-1 Nephelometric Turbidity Units; and

has a pH between 6.5 and 7.5.

The purified water is supplied to the heating tank 23, where it undergoes a heating cycle to a temperature of 74 degrees Celsius.

The heated purified water is then fed into the mixer 26 through the shunt valve 28. An additive is added to the hopper 30 and dispensed into the mixer 26 through the dispensing valve 32 for mixing with the heated purified water in the mixer 26 to form a mixture.

Heated purified water is also fed into the blender 36 through the main pipe 24a, the main valve 38 and the main flowmeter 44 and blended therein with the mixture received from the mixer 26 through the mix valve 40 and the mix flowmeter 46.

The blend from the blender 36 is then discharged through the discharge line 48 via the discharge valve 50 for freezing into ice.

It will be appreciated that the shunt valve 28, the dispensing valve 32, the main valve 38 and the mix valve 40 provide ways to control the amount of additive received from the hopper 30 that is combined with substantially pure water from the filtration stage 16 and thus ultimately the composition of the blend discharged through the discharge line 48. It will further be appreciated that the mix-tester 34, the blend-tester 42, the main flowmeter 44, and the mix flowmeter 46 provide ways to monitor these amounts for the purpose of adjusting the shunt valve 28, the dispensing valve 32, the main valve 38 and the mix valve 40 to control the composition of the blend discharged through the discharge line 48. Those skilled in the art will understand that, for the purpose of illustration, more control elements (the shunt valve 28, the dispensing valve 32, the main valve 38 and the mix valve 40) and monitoring elements (the mix-tester 34, the blend-tester 42, the main flowmeter 44, and the mix flowmeter 46) have been included in this embodiment than are necessary to control the composition of the blend discharged through the discharge line 48.

Against the conventional wisdom, experimentation has shown that an ice slab having a fast, hard, uniform surface that consistently resists rutting, chipping, cutting, sinking and sintering during use over an extended period of time can be repeatably created if the floodwater being frozen has at least one of the following characteristics:

total alkalinity (CaCO₃) between 180-200 mg/L,

hardness (CaCO₃) between 9-12 mg/L, and

turbidity between 0-1 Nephelometric Turbidity Units.

It has also been found to be secondarily desirable that the floodwater has any of the following characteristics:

pH between 7.5 and 8.5,

bicarbonate alkalinity (HCO₃) between 190-210 mg/L,

sulphate concentration (SO₄) between 8-10 mg/L,

sodium concentration (Na) between 100-130 mg/L,

calcium concentration (Ca) between 3-6 mg/L,

chloride concentration (Cl) between 55-70 mg/L, and

silicon concentration (SiO₂) between 3-7 mg/L.

At least some of these characteristics can be simply obtained by mixing/blending a known quantity of substantially pure water with a known quantify of additive that will mix with and at least partially dissolve in the water to yield these characteristics. Heating the water encourages such dissolution.

For example, these characteristics have been repeatably achieved by mixing/blending 568 litres of substantially pure water with 202 grams of an additive comprising 149 grams of sodium bicarbonate (NaHCO₃), 48 grams of sodium chloride (NaCl), and 5 grams gypsum (CaSO₄.2H2O).

Expressed more generally, it has been found that an ice slab having a fast, hard, uniform surface that consistently resists rutting, chipping, cutting, sinking and sintering during use over an extended period of time can be repeatably created if the floodwater being frozen is substantially pure water except for the fact that it includes 36×10⁻² grams per litre of the additive, which corresponds to 26×10⁻² grams per litre of sodium bicarbonate (NaHCO₃), 84×10⁻³ grams per litre of sodium chloride (NaCl), and 96×10⁻⁴ grams per litre of gypsum (CaSO₄.2H2O).

Those skilled in the art will appreciate that other additives, for example various buffering salts, would also produce desirable results without departing from the teaching of the present invention. Those skilled in the art will also appreciate that the freezing point of a liquid is a colligative property.

Thus, it will be seen from the foregoing embodiments and examples that there has been described a way to make an ice slab that has a fast, hard, uniform surface that consistently resists rutting, chipping, cutting, sinking and sintering during use over an extended period of time.

While specific embodiments of the invention have been described and illustrated, such embodiments should be considered illustrative of the invention only and not as limiting the invention as construed in accordance with the accompanying claims. In particular, all quantities described have been determined empirically and those skilled in the art might well expect a wide range of values surrounding those described to provide similarly beneficial results.

It will be understood by those skilled in the art that various changes, modifications and substitutions can be made to the foregoing embodiments without departing from the principle and scope of the invention expressed in the claims made herein.

For example, if the water received at the shut-off valve 14 were either already of a commercially practical purity or heated to a temperature close to 74 degrees Celsius, then the filtration stage 16 or the heating tank 23 might respectively be omitted from the water treatment system 10. To further simplify the water treatment system 10, mixing and blending could be accomplished in a single step.

As another example, instead of implementing an automatic control module 52, similar results could be achieved by having a technician observe the monitoring elements (mix-tester 34, blend-tester 42, main flowmeter 44, mix flowmeter 46) and set the control elements (shunt valve 28, dispensing valve 32, main valve 38, mix valve 40). Furthermore, once the water treatment system 10 was calibrated, some or all of the monitoring elements (mix-tester 34, blend-tester 42, main flowmeter 44, mix flowmeter 46) could be omitted and the control elements (shunt valve 28, dispensing valve 32, main valve 38, mix valve 40) could be fixed, such that a known amount of additive added into the hopper 30 could be mixed with a known flow of substantially purified water to produce the desired composition of floodwater at the discharge line 48. In this latter situation for example, a technician, either on-site or off-site, could act as a blend-tester 42, monitoring sample batches of the blend to ensure it has the desired properties and determining how to adjust the control elements (shunt valve 28, dispensing valve 32, main valve 38, mix valve 40) should an adjustment in the properties of the blend be appropriate.

While the invention has been described as having particular application for hockey, those skilled in the art will recognize it has wider application.

What is claimed is:

1. A method of processing water to create floodwater for ice-making, comprising: mixing an additive into the water to produce floodwater having at least one property selected from the group comprising:
(a) 180 mg/L≦total alkalinity (CaCO₃)≦200 mg/L,
(b) 9 mg/L≦hardness (CaCO₃)≦12 mg/L, and
(c) 0 Nephelometric Turbidity Units≦turbidity≦1 Nephelometric Turbidity Units.

2. A method as claimed in claim 1, further comprising: filtering the water to a commercially practical degree of purity before mixing the additive into the water.

3. A method as claimed in claim 2, wherein filtering the water comprises at least one of:
a) mechanically filtering the water,
b) deionizing the water, and
c) reverse-osmotically filtering the water.

4. A method as claimed in claim 3, wherein water filtered to a commercially practical degree of purity is characterized by having:
a) less than one part per million of each of aluminum, antimony, arsenic, barium, beryllium, bismuth, boron, cadmium, chromium, cobalt, copper, lead, lithium, molybdenum, nickel, phosphorus, selenium, silicon, silver, strontium, sulphur, thalium, vanadium, calcium, magnesium, manganese, sodium, potassium, chloride (Cl), sulphate (SO₄), hardness (CaCO₃), bicarbonate alkalinity (HCO₃), hydroxide alkalinity (CO₃), carbonate alkalinity (OH),
b) less than five parts per million of total alkalinity (CaCO₃),
c) a turbidity between 0-1 Nephelometric Turbidity Units, and
d) a pH between 6.5 and 7.5.

5. A method as claimed in claim 3, further comprising: heating the filtered water before mixing the additive into the water.

6. A method as claimed in claim 1, wherein mixing an additive comprises mixing an additive into the water until the floodwater has at least one property selected from the group comprising:
a) 7.5≦pH≦8.5,
b) 190 mg/L≦bicarbonate alkalinity (HCO₃)≦210 mg/L,
c) 8 mg/L≦sulphate concentration (SO₄)≦10 mg/L,
d) 100 mg/L≦sodium concentration (Na)≦130 mg/L,
e) 3 mg/L≦calcium concentration (Ca)≦6 mg/L,
f) 55 mg/L≦chloride concentration (Cl)≦70 mg/L, and
g) 3 mg/L≦silicon concentration (SiO₂) between≦7 mg/L.

7. A method as claimed in claim 1, wherein mixing an additive comprises mixing a buffering salt into the filtered water.

8. A method as claimed in claim 2, wherein mixing an additive comprises mixing into the filtered water a composition comprising: 74% by mass sodium bicarbonate (NaHCO₃), 24% by mass sodium chloride (NaCl) and 2% by mass gypsum (CaSO₄.2H2O).

9. A method as claimed in claim 8, wherein mixing said composition into the filtered water comprises: mixing 36×10⁻² grams of the additive into each litre of filtered water.

10. A method as claimed in claim 2, wherein mixing an additive comprises:
a) mixing said additive into a first amount of filtered water to create a mixture, and
b) blending said mixture into a second amount of filtered water.

11. A composition of matter for mixing with water to create floodwater for making ice, such that the composition when added to water creates floodwater that has at least one property selected from the group comprising:
a) 180 mg/L≦total alkalinity (CaCO₃)≦200 mg/L,
b) 9 mg/L≦hardness (CaCO₃)≦12 mg/L, and
c) 0 Nephelometric Turbidity Units≦turbidity≦1 Nephelometric Turbidity Units.

12. A composition of matter as claimed in claim 11, wherein the water has been purified to a commercially practical degree of purity.

13. A composition of matter as claimed in claim 12, wherein the water is characterized by having:
a) less than one part per million of each of aluminum, antimony, arsenic, barium, beryllium, bismuth, boron, cadmium, chromium, cobalt, copper, lead, lithium, molybdenum, nickel, phosphorus, selenium, silicon, silver, strontium, sulphur, thalium, vanadium, calcium, magnesium, manganese, sodium, potassium, chloride (Cl), sulphate (SO₄), hardness (CaCO₃), bicarbonate alkalinity (HCO₃), hydroxide alkalinity (CO₃), carbonate alkalinity (OH),
b) less than five parts per million of total alkalinity (CaCO₃),
c) a turbidity between 0-1 Nephelometric Turbidity Units, and
d) a pH between 6.5 and 7.5.

14. A composition of matter as claimed in claim 12, wherein the floodwater has at least one property selected from the group comprising:
a) 7.5≦pH≦8.5,
b) 190 mg/L≦bicarbonate alkalinity (HCO₃)≦210 mg/L,
c) 8 mg/L≦sulphate concentration (SO₄)≦10 mg/L,
d) 100 mg/L≦sodium concentration (Na)≦130 mg/L,
e) 3 mg/L≦calcium concentration (Ca)≦6 mg/L,
f) 55 mg/L≦chloride concentration (Cl)≦70 mg/L, and
g) 3 mg/L≦silicon concentration (SiO₂) between≦7 mg/L.

15. A composition of matter as claimed in claim 12, wherein the composition comprises a buffering salt.

16. A composition of matter as claimed in claim 12, wherein the composition comprises:
a) 74% by mass sodium bicarbonate (NaHCO₃),
b) 24% by mass sodium chloride (NaCl), and
c) 2% by mass gypsum (CaSO₄.2H2O).

17. A composition of matter for making ice, comprising a mixture of:
a) water having a commercially practical degree of purity, and
b) 36×10⁻² grams of the composition of claim 16 for each litre of water.

18. A composition of matter for making ice, the composition comprising water that has a property selected from the group consisting of:
a) 180 mg/L≦total alkalinity (CaCO₃)≦200 mg/L,
b) 9 mg/L≦hardness (CaCO₃)≦12 mg/L, and
c) 0 Nephelometric Turbidity Units≦turbidity≦1 Nephelometric Turbidity Units.

19. A composition of matter as claimed in claim 18, wherein the composition further has a property selected from the group consisting of:
a) 7.5≦pH≦8.5,
b) 190 mg/L≦bicarbonate alkalinity (HCO₃)≦210 mg/L,
c) 8 mg/L≦sulphate concentration (SO₄)≦10 mg/L,
d) 100 mg/L≦sodium concentration (Na)≦130 mg/L,
e) 3 mg/L≦calcium concentration (Ca)≦6 mg/L,
f) 55 mg/L≦chloride concentration (Cl)≦70 mg/L, and
g) 3 mg/L≦silicon concentration (SiO₂) between≦7 mg/L.

20. A composition of matter as claimed in claim 18, wherein the composition further comprises a buffering salt.

21. A composition of matter as claimed in claim 18, wherein the composition further comprises:
a) 26×10⁻² grams of sodium bicarbonate (NaHCO₃) for each litre of water,
b) 84×10⁻³ grams of sodium chloride (NaCl) for each litre of water, and
c) 96×10⁻⁴ grams of gypsum (CaSO₄.2H2O) for each litre of water.

22. An apparatus for processing water into floodwater for making ice, comprising:
a) a mixer connected to receive water having a commercially practical degree of purity and to receive an additive and operable to mix the water and the additive to create a floodwater mixture.

23. An apparatus as claimed in claim 22, further comprising:
a) a filtration stage operable to filter water and connected to supply the filtered water to the mixer.

24. An apparatus as claimed in claim 23, wherein the filtration stage further comprises at least one of:
a) a mechanical filter,
b) a deionization filter, and
c) a reverse-osmosis filter.

25. An apparatus as claimed in claim 22, further comprising:
a) a heater operable to heat water and connected to supply the heated water to the mixer.

26. An apparatus as claimed in claim 22, further comprising: a dispensing valve operable to control the amount of additive dispensed into the mixer for mixing with the water.

27. An apparatus as claimed in claim 26, further comprising: a mix-tester operable to test a property of the mixture within the mixer.

28. An apparatus as claimed in claim 27, wherein the mix-tester is operable to test at least one property selected from the group comprising:
a) total alkalinity (CaCO₃),
b) hardness (CaCO₃), and
c) turbidity.

29. An apparatus as claimed in claim 28, wherein mix-tester is operable to test at least one property selected from the group comprising:
a) pH,
b) bicarbonate alkalinity (HCO₃),
c) sulphate concentration,
d) sodium concentration (Na),
e) calcium concentration (Ca),
f) chloride concentration (Cl), and
g) silicon concentration (SiO₂).

30. An apparatus as claimed in claim 27, wherein the dispensing valve is responsive to the mix-tester.

31. An apparatus as claimed in claim 30, further comprising: a shunt valve operable to control the amount of water supplied to the mixer for mixing with the additive.

32. An apparatus as claimed in claim 31, wherein the shunt valve is responsive to the mix-tester.

33. An apparatus as claimed in claim 32, further comprising: a blender connected to receive water having a commercially practical degree of purity and mixture from the mixer and operable to blend the water and the mixture to create a floodwater blend.

34. An apparatus as claimed in claim 33, further comprising: a mix valve operable to control the amount of mixture received by the blender for blending with the water.

35. An apparatus as claimed in claim 34, further comprising: a main valve operable to control the amount of water received by the blender for blending with the mixture.

36. An apparatus as claimed in claim 35, further comprising: a blend-tester operable to test a property of the blend within the blender.

37. An apparatus as claimed in claim 36, wherein the blend-tester is operable to test at least one property selected from the group comprising:
a) total alkalinity (CaCO₃),
b) hardness (CaCO₃), and
c) turbidity.

38. An apparatus as claimed in claim 37, wherein blend-tester is operable to test at least one property selected from the group comprising:
a) pH,
b) bicarbonate alkalinity (HCO₃),
c) sulphate concentration,
d) sodium concentration (Na),
e) calcium concentration (Ca),
f) chloride concentration (Cl), and
g) silicon concentration (SiO₂).

39. An apparatus as claimed in claim 36, wherein at least one of the mix valve and the main valve is responsive to the blend-tester.

40. An apparatus as claimed in claim 39, further comprising: a mix flowmeter operable to measure the flow of mixture into the blender.

41. An apparatus as claimed in claim 40, wherein the mix valve is responsive to the mix flowmeter.

42. An apparatus as claimed in claim 39, further comprising: a main flowmeter operable to measure the flow of water through the main valve into the blender.

43. An apparatus as claimed in claim 42, wherein the main valve is responsive to the main flowmeter.

44. An apparatus as claimed in claim 43, further comprising: a control module responsive to at least one of:
a) the mix-tester,
b) the blend-tester,
c) the mix flowmeter, and
d) the main flowmeter.

45. An apparatus as claimed in claim 44, wherein at least one of:
a) the dispensing valve,
b) the shunt valve,
c) the mix valve, and
d) the main valve,
is responsive to the control module.

46. An apparatus as claimed in claim 45, wherein the control module is operable to control at least one of:
a) the dispensing valve,
b) the shunt valve,
c) the mix valve, and
d) the main valve,
such that the blend has at least one property selected from the group comprising:
i) 180 mg/L≦total alkalinity (CaCO₃)≦200 mg/L,
ii) 9 mg/L≦hardness (CaCO₃)≦12 mg/L, and
iii) 0 Nephelometric Turbidity Units≦turbidity≦1 Nephelometric Turbidity Units.

47. An apparatus as claimed in claim 46, wherein the control module is operable to control at least one of:
a) the dispensing valve,
b) the shunt valve,
c) the mix valve, and
d) the main valve,
such that the blend has at least one property selected from the group comprising:
i) 7.5≦pH≦8.5,
ii) 190 mg/L≦bicarbonate alkalinity (HCO₃)≦210 mg/L,
iii) 8 mg/L≦sulphate concentration (SO₄)≦10 mg/L,
iv) 100 mg/L≦sodium concentration (Na)≦130 mg/L,
v) 3 mg/L≦calcium concentration (Ca)≦6 mg/L,
vi) 55 mg/L≦chloride concentration (Cl)≦70 mg/L, and
vii) 3 mg/L≦silicon concentration (SiO₂) between≦7 mg/L.
